(19) United States
(12) Patent Application Publication
(10) Pub. No.: US 2026/0334513 A1
(43) Pub. Date: Oct. 29, 2026

(54) SHAKER TABLE APPARATUS AND METHOD FOR PURIFYING ANIMAL PROTEIN MEAL

(71) Applicant: Joe Hubbard, Kansas City, MO (US)

(72) Inventor: Joe Hubbard, Kansas City, MO (US)

(21) Appl. No.: 19/347,055

(22) Filed: Oct. 1, 2025

Related U.S. Application Data
(60) Provisional application No. 63/796,309, filed on Apr. 28, 2025.

(51) Int. Cl. A23L 5/20

(52) U.S. Cl. CPC A23L 5/20

(57) ABSTRACT

A shaker table for purifying powdered mixtures includes a base, an actuator assembly, a sifting table, and sifting plates. The actuator assembly may apply oscillation and/or rotational movement across a longitudinal axis to move powder across the surface of the sifting table.

Powder is separated by the sifting plates based on size. Multiple sifting trays are provided for routing sifted powder for further processing, disposal, or use in end products. The shaker table may include additional frames for support or connection to certain components. Magnetic separators and diverters may be included to remove ferromagnetic particulates and control powder flow, respectively.

A process for purifying powder mixtures includes loading a powder mixture on one end of a novel shaker table disclosed herein, initiating the actuator assembly to move the powder mixture across the sifting plates, and routing sifted powder for further processing, disposal, or use in end products.

### CROSS-REFERENCE TO RELATED APPLICATIONS

The present application is a nonprovisional application and claims the benefit of priority under 35 U.S.C. § 119(e) of U.S. Nonprovisional Application No. 63/796,309 entitled “SYSTEM AND METHOD FOR PURIFYING ANIMAL PROTEIN MEAL,” filed on Apr. 28, 2025 by Joe Hubbard, the entirety of which is hereby incorporated by reference.

The present application is related to Nonprovisional application Ser. No. 19/347,036 entitled “SYSTEM AND METHOD FOR PURIFYING ANIMAL PROTEIN MEAL,” filed on Oct. 1, 2025.

### STATEMENT REGARDING FEDERALLY SPONSORED RESEARCH OR DEVELOPMENT (IF APPLICABLE)

N/A

### BACKGROUND OF THE INVENTION

### Field of the Invention

This invention relates generally to animal feeding-stuffs, and more particularly to working-up of proteins for foodstuffs.

### Background of the Prior Art

First, processing or manufacturing powder-based products may result in contamination of the powder. Equipment used in the process may chip, flake, or break, adding metal or plastic debris into the powder.

Second, it is desirable to separate some powder mixtures based on certain aspects, such as particle size. For example, animal protein meal is a powder made from processed animals and is used to produce food for pets and livestock. Animal protein meal includes substantial ash and bone content, along with the previously mentioned metal and plastic contaminants.

To address these issues, some processors utilize shaker tables, which are tray-like tables with surface sifting screens. Powder is placed on the table and the table oscillates, vibrating the powder across the sifting screens. Material of a size smaller than the sifting screen perforations will fall through to the tray and larger material will be retained by the screens.

Traditional shaker tables are inefficient, inconvenient, and only offer one level of purification. They are inefficient and inconvenient because users must manually unload both the purified and unpurified portions of powder, thereby slowing down the manufacturing process.

Manual loading and unloading of powder can be alleviated by certain conveyor systems, such as an auger-driven conveyor system. However, implementing a shaker table and an auger conveyer system requires significant expense and free space. This makes implementation cost ineffective, especially considering the benefit is merely one level of purification.

A novel method of protein meal purification is disclosed in a related patent application. Said method includes multiple traditional shaker tables connected by an auger conveyer system to provide multiple levels of purification. Although this novel method is effective at producing purified animal protein meal with controlled formulas, it still requires significant resources to implement. Thus, a need exists for an efficient way to purify powder mixtures.

### BRIEF SUMMARY OF THE INVENTION

This invention is a shaker table apparatus and method of purifying powder mixtures. The apparatus generally comprises a base, an eccentric frame, an actuator assembly, and a sifting assembly. A preferred embodiment further comprises an intermediate frame for added support and an auger conveyer system for increased efficiency.

The shaker table disclosed herein includes multiple means of purifying animal protein meal. The multiple sifting screens provide users the ability to separate a powder mixture into multiple portions. This may be advantageous when, for example, a portion of the powder mixture is useable, a portion is not useable, and a portion needs to be further refined or milled before determining usability.

The auger conveyer of the preferred embodiment and the multiple sifting plates of the shaker table work to increase the efficiency of powder purification and to reduce the resource demand of powder purification. The auger conveyer system eliminates the need for substantially all manual loading and moving of the powder mixture. The multiple sifting plates maintains the thorough purification process of the novel method of protein meal purification while eliminating the need for multiple shaker tables. This efficiency both reduces expenses and the amount of industrial space needed.

Various embodiments of the shaker table include diverters on the surface of the sifting plates. The diverters provide control of the flow of powder on the sifting table, aiding to prevent powder from moving too quickly across the sifting plates (avoiding sufficient separation) and to prevent powder from clumping and hindering the flow of powder across the shaker table.

### BRIEF DESCRIPTION OF THE DRAWINGS

FIG. 1 is a side perspective view of an embodiment of a shaker table.

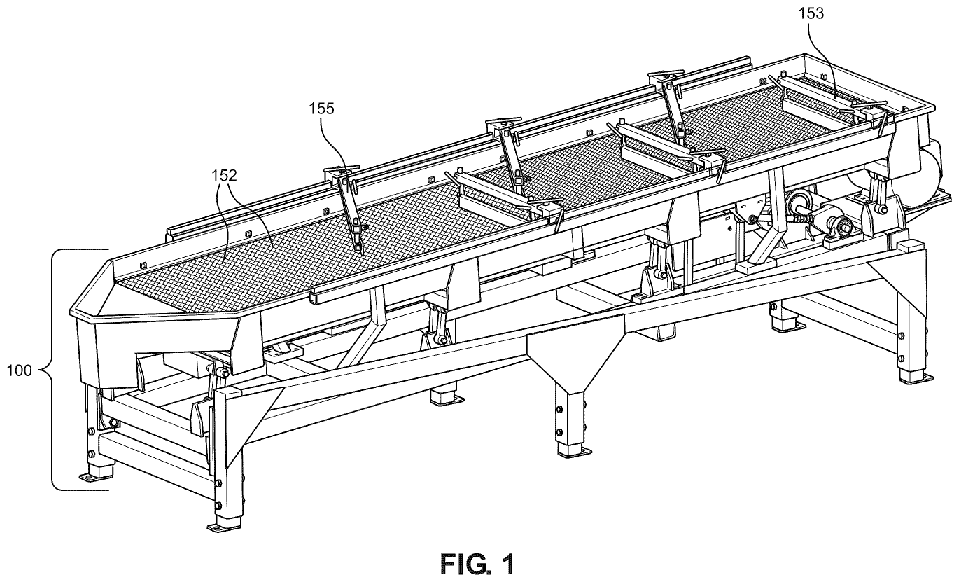

FIG. 2 is a side perspective view of an embodiment of a base.

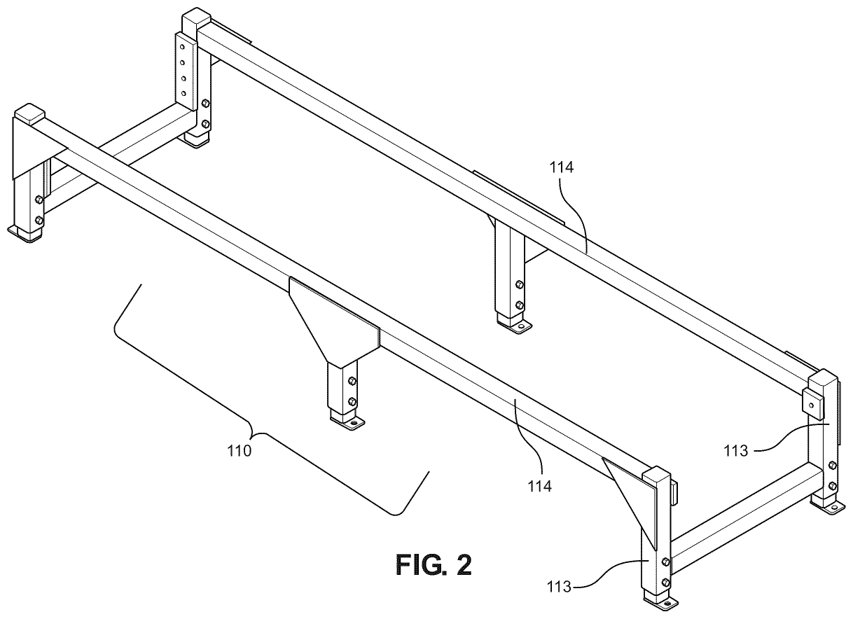

FIG. 3 is a side perspective view of an embodiment of an eccentric frame.

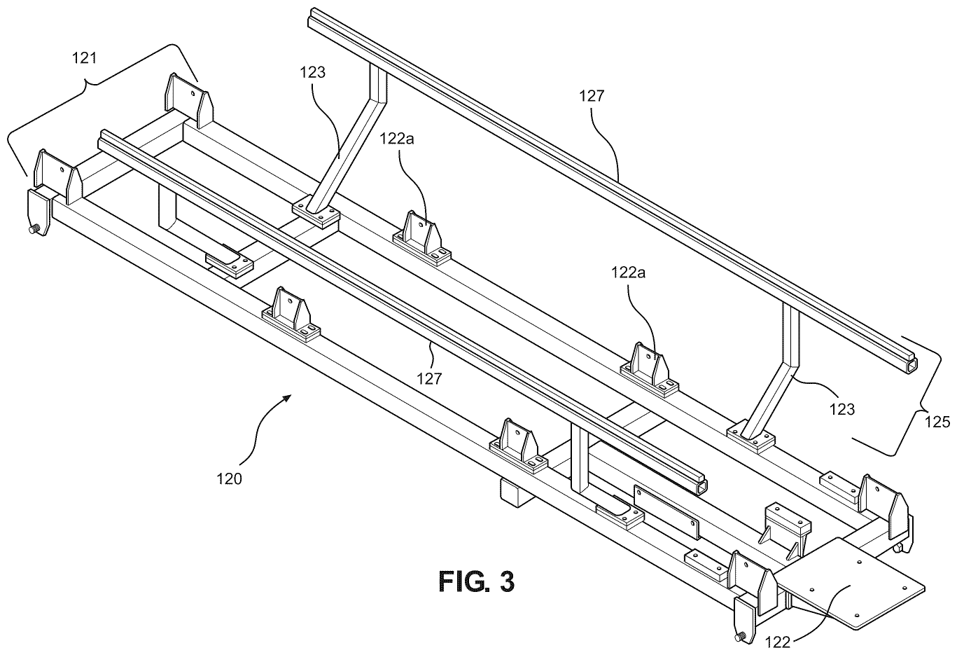

FIG. 4 is a side elevation view of an embodiment of a shaker table.

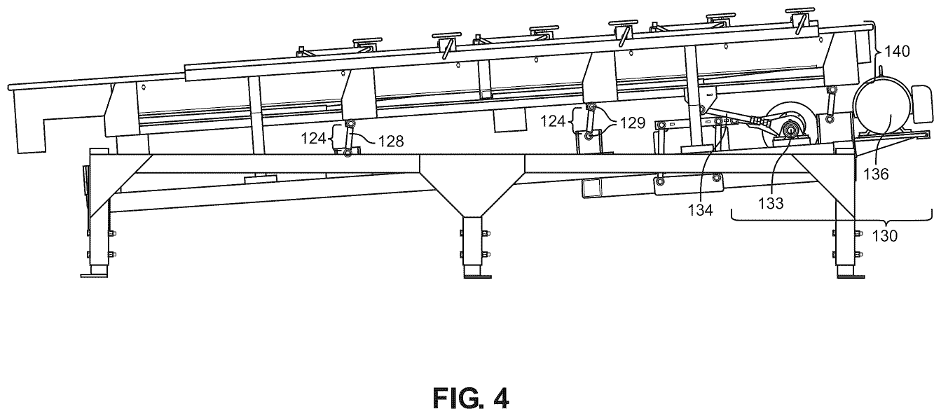

FIG. 5 is a side perspective view of an embodiment of an intermediate frame.

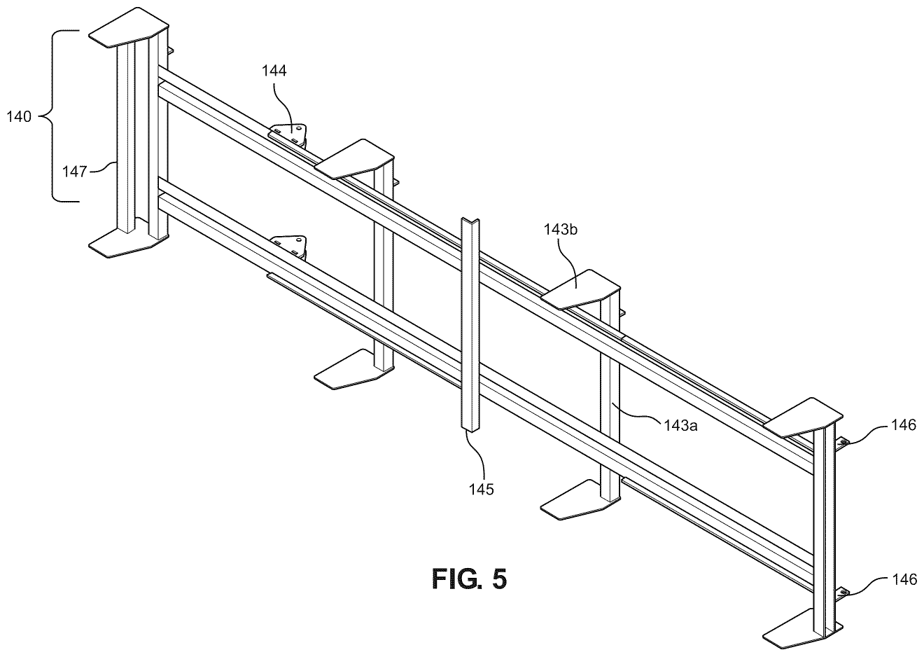

FIG. 6 is a side perspective view of an embodiment of a sifting assembly.

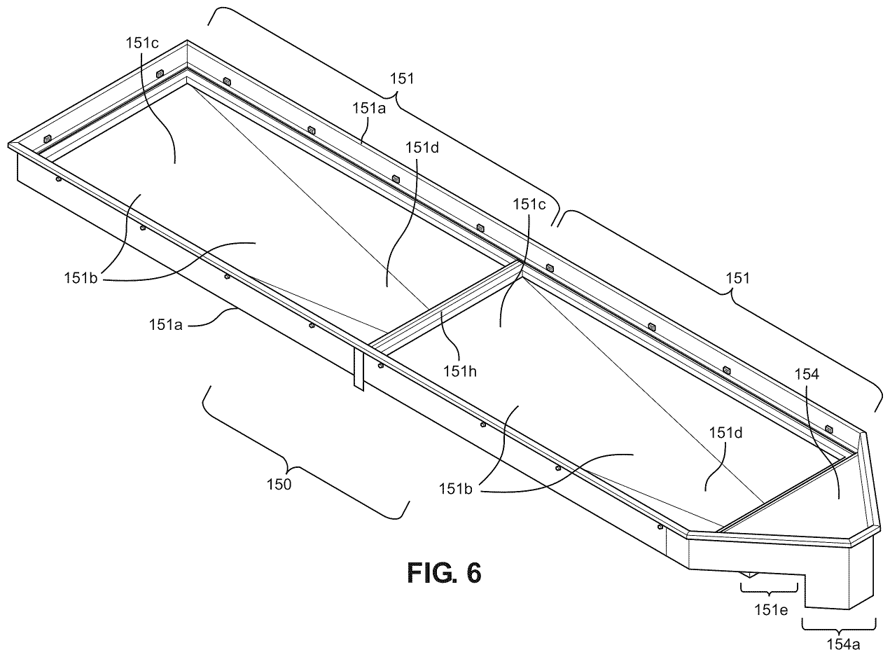

FIG. 7 is a side perspective view of an embodiment of a shaker table.

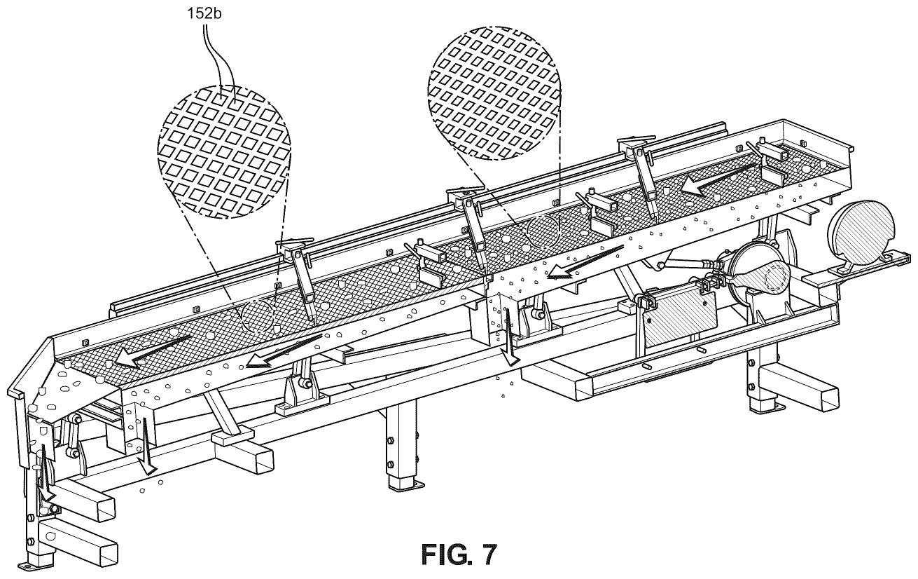

FIG. 8 is a top plan view of an embodiment of a shaker table.

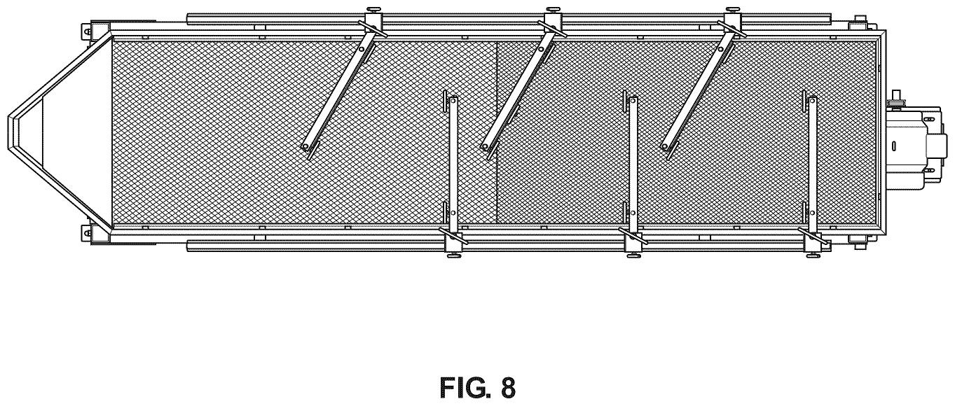

### DETAILED DESCRIPTION OF THE INVENTION

This invention is a system and method 100 for purifying animal protein meal and for controlling nutritional content such as ash. The system and method remove most physical contaminants from animal protein meal, such as metal fragments, bone fragments, and plastics. The system and method also remove insufficiently ground particles and produce two separate batches of purified animal protein meal: one with high ash content, and one with little to no ash content.

### Base 110

The base 110 has a top portion and a bottom portion. The bottom portion is four or more legs 113 engaging the ground or supporting surface. The top portion is a flat surface in the shape of the outline of a rectangle. The top portion is formed by at least four horizontal beams 114 that connect the legs 113 so that each leg 113 is connected to two other legs 113. The beams 114 have a square profile, so that the top portion is a flat surface, rectangular surface with a hollow center.

### Eccentric Frame 120

The eccentric frame 120 comprises a metal frame 121 with a general shape of the internal border of the top portion of the base 110. The eccentric frame 120 includes a lower surface 122, rigid linkages 123, eccentric linkages 124, and an upper linking portion 125.

The lower surface 122 of the eccentric frame 120 is a flat surface providing support for the actuator assembly 130. The actuator assembly 130 is fixingly attached to the lower surface 122 by means such as bolts.

In a preferred embodiment, a portion of the lower surface 122 protrudes horizontally beyond the length endpoint of the base 110.

The rigid linkages 123 of the eccentric frame 120 are metal beams extending vertically from the eccentric frame 120 and connecting the eccentric frame 120 with the upper linking portion 125. The upper linking portion 125 comprises two horizontal beams 127 fixingly attached to the outer sides of the table assembly 150.

The eccentric linkages 124 are pivot rods 128 with ball bearings 129 on each end of the pivot rods 128. One end of each pivot rod 128 is pivotally connected to the eccentric frame 120 and one end is pivotally connected to the intermediate frame 140. In a preferred embodiment, the eccentric linkages 124 are connected to square or rectangular protrusions 122a extending vertically from the eccentric frame 120.

### Actuator Assembly 130

The actuator assembly 130 is a mechanical actuator 131 mounted to the eccentric frame 120 and connected to the intermediate frame 140. Exemplary actuators 131 include motor and belt assemblies, pneumatic motors, and linear actuators. Exemplary means to connect the actuator 131 to the eccentric frame 120 includes a drive shaft 133, eccentric arm 134, and pivot rods 128.

In a preferred embodiment, the actuator assembly 130 is a belt drive and pulley system, comprising a motor 136, belt, and eccentric arm 134. The motor 136 is electrically powered by an external power source. The belt is connected to the motor 136 and the eccentric arm 134. The eccentric arm 134 is connected to the intermediate frame 140 in a configuration allowing the eccentric arm 134 to rotate counterclockwise about the longitudinal axis of the shaker table 100. The motor 136 pulls the belt in a counterclockwise manner, causing a counterclockwise rotation of the eccentric arm 134. The eccentric arm 134 moves counterclockwise about the longitudinal axis of the shaker table 100, causing the intermediate frame 140, and thus the sifting assembly 150, to move about its longitudinal axis from one end to the other.

The actuator assembly 130 may rotate the sifting assembly 150 in a circular trajectory, or may convert the motion into linear motion, resulting in linear movements generally consisting of movements in the direction sequence upward, forward, downward, and backward, wherein forward means the direction of the discharge end 154 of the sifting assembly 150.

### Intermediate Frame 140

The intermediate frame 140 is a metal frame connecting the sifting assembly 150 to the eccentric frame 120. The intermediate frame 140 comprises a series of metal beams forming a shape substantially similar to the internal border of the top portion of the base 110, mounts 143a, 143b, and mounting plates 144.

The mounts 143a, 143b are mounting beams 143a with side mounts 143b at each end of each beam 143a. The mounting beams 143a are fixingly attached to the intermediate frame 140 perpendicular to the longitudinal axis. When installed, the side mounts 143b are oriented upwards and towards the sifting assembly 150. The side mounts 143b engage the outer sides 151a of the sifting assembly 150, applying pressure to the sifting assembly 150, connecting the intermediate frame 140 to the sifting assembly 150.

The mounting plates 144 are plates fixingly attached to the sides of the intermediate frame 140. When installed, the mounting plates 144 are oriented downward and opposite the side mounts 143b. Each mounting plate 144 includes an aperture configured to receive a coupling, which couples the mounting plate 144 to the eccentric arm 134.

In a preferred embodiment, the intermediate frame 140 includes four mounts 143a, 143b, two mounting plates 144, and further comprises a support beam 145 and two mounting tabs 146. The mounts 143a, 143b are evenly spaced along the intermediate frame 140 with one mount 143a, 143b at each end. The mount 143a, 143b attached to one end of the intermediate frame 140, said end of the intermediate frame 140 being configured to be closest to the actuator assembly 130 when fully installed, includes an additional beam 147 attached to the side mounts 143b, which provides further support to the sifting assembly 150. The support beam 145 is fixingly attached to the intermediate frame 140 across the central point in an orientation parallel to the mounts 143a, 143b. The mounting tabs 146 are small protrusions vertically extending from the end of the intermediate frame 140 opposite the end including the side mount 143b with an additional supportive beam 147. When installed, the mounting tabs 146 are oriented downward and attach to the eccentric frame 120, providing further support to the sifting assembly 150.

### Sifting Assembly 150

The sifting assembly 150 comprises a sifting pan 151, one or more sifting plates 152, a feed end 153, and a disposal end 154.

The sifting pan 151 comprises one or more tray sections 151b enclosed by side walls 151a, each tray section 151b having a feeding end 151c and a discharge end 151d. The feeding end 151c is the end of the tray section 151b opposite the discharge end 151d, which generally receives material passing through the sifting plates 152. The discharge end 151d is the terminal end and includes a discharge opening 151e. A series of tray sections 151b can be adjoined longitudinally.

In a preferred embodiment, the sifting pan 151 comprises two tapered tray sections 151b arranged longitudinally in series, each with a declining trapezoidal floor bounded laterally by inclined triangular ramps and enclosed by side walls 151a. The two trays 151b are separated by a shared intermediate wall 151h, which divides the interior into two adjacent flow channels, each tapering toward its own discharge end 151d.

The one or more sifting plates 152 are perforated sheets including interspaced apertures 152b. The apertures 152b may be regularly spaced and uniform in size and shape.

If more than one sifting plate 152 is used and the apertures 152b are not symmetrical shapes, the sifting plates 152 may be installed with alternating shape orientations so that shape orientations between sifting plates 152 align perpendicularly.

In a preferred embodiment, the apertures 152b are regularly spaced, utilizing a repeating diamond-shaped pattern.

In a preferred embodiment, each sifting plate 152 is 16.5″ by 17.25″.

In a preferred embodiment, each tray section 151b of the sifting pan 151 is capped by 8 sifting plates 152, organized as two rows of four sifting plates 152.

In a preferred embodiment, each row of sifting plates 152 is installed so that the aperture orientations are aligned parallel to each other and perpendicular to the aperture orientations of each preceding and subsequent row of sifting plates 152.

The disposal end 154 of the sifting assembly 150 is a discharge chute 154a or opening. The disposal end 154 and the discharge end 151d of a tray section 151b can be configured conversely and interchangeably so that either end produces undesirable portions of a separated material while the other produces desirable portions of the separated material.

In a preferred embodiment, the discharge end 151d of the one or more tray sections 151b produces desirable portions of separated material and the disposal end 154 of the sifting assembly 150 produces undesirable portions of the separated material.

The feed end 153 of the sifting assembly 150 is the end opposite the disposal end 154. In a preferred embodiment, particulate material is fed onto the sifting assembly 150 at the feed end 153 via an auger conveyor system.

The sifting assembly 150 may optionally include one or more diverters 155. The diverters 155 are bars or material elongated across the sifting plates 152 and removably attached to the upper linkage portion 125 of the eccentric frame 120. Diverters 155 may be attached by means including quick-release pins. Diverters 155 redirect the flow of particulates moving across the sifting plates 152, thereby affecting the speed at which particulates pass through the sifting assembly 150.

In a preferred embodiment, the sifting assembly 150 includes a series of six diverters 155. The series of diverters 155 are attached on alternating sides of the upper linkage portion 125 of the eccentric frame 120. Each diverter 155 on one side is oriented perpendicular to the longitudinal axis of the sifting assembly 150, and each diverter 155 on the opposite side is oriented approximately midway between parallel to and perpendicular to the longitudinal axis of the sifting assembly 150.

### Method

The present invention further provides a method 200 for purifying animal protein meal using the system 100 described above. The method 200 begins with loading or feeding animal protein meal 201 onto a shaker table 150 or sifting table 150, the shaker table 150 comprising a fixed base 110, an actuator assembly 130 mounted directly or indirectly to the base 110, a drive component connecting the actuator 131 to the sifting assembly 150, and one or more sifting plates 152 mounted to and covering the upper open portion 151 of the sifting pan 151. The sifting plates 152 include evenly spaced perforations 152b sized to allow passage of particles of particular sizes.

Once the animal protein meal 201 is loaded onto the sifting assembly 150, the actuator assembly 130 is activated to move the sifting assembly 150 about the longitudinal axis. This motion causes the animal protein meal 201 to traverse the sifting plates 152, resulting in particles of certain sizes falling through the perforations 152b into the underlying tray sections 151b. Particles that are too large to pass through the perforations 152b remain atop the sifting plates 152 and are routed toward the disposal end 154 of the sifting assembly 150.

The method 200 further includes separating the animal protein meal 201 into distinct portions based on particle size. Particles passing through each sifting plate 152 are collected in separate tray sections 151b or routed into discrete containers 202, while particles remaining atop the sifting plates 152 are directed into a separate container 203. This separation allows for concurrent production of purified animal protein meal fractions having different ash content or particle size distributions.

In certain embodiments, the method 200 includes separating particles with ferromagnetic properties by positioning one or more magnetic separators 204 in proximity to the sifting assembly 150. The magnetic separators 204 attract ferromagnetic fragments from the animal protein meal 201, preventing contamination of the purified fractions.

The method 200 may further include feeding the animal protein meal 201 onto the sifting assembly 150 using an auger conveyor system. The auger conveyor system also transfers the separated portions 202, 203 for further processing, combination into an end product, or disposal.

In a preferred embodiment, the actuator assembly 130 is configured to cause the sifting assembly 150 to move about the longitudinal axis in a manner that generally conveys the animal protein meal 201 from the feed end 153 toward the discharge end 154. The motion may be circular, linear, or a combination thereof, with the longitudinal movement facilitated by the configuration of the eccentric arm 134 and belt drive.

The method 200 may further include controlling the flow of animal protein meal 201 atop the sifting plates 152 using one or more diverters 155. Diverters 155 are positioned across the sifting plates 152 to adjust the velocity, distribution, and trajectory of the particles, optimizing separation efficiency.

Additionally, the method 200 may utilize gravity to assist in moving the animal protein meal 201 from the feed end 153 to the discharge end 154. This can be achieved by adjusting the height of the legs 113 of the base 110, thereby creating a slope with a decline angle in the direction of the discharge end 154, promoting continuous particle movement and efficient separation.

What is claimed is:

1. A shaker table for purifying powder, said shaker table comprising:
(a) a fixed base;
(b) an actuator assembly, comprising an actuator mounted directly or indirectly to the base, and a drive component connecting the actuator to the sifting table, transferring motion to the sifting table when the actuator is activated;
(c) a sifting table; comprising a lower tray portion and an upper open portion, said lower tray portion having at least one discharge opening; and
(d) more than one sifting plate being mounted to and covering the upper open portion of the sifting table, said sifting plates having evenly spaced perforations.

2. The shaker table of claim 1, further comprising an eccentric frame having a general shape of the internal border of the base, said eccentric frame being fixingly attached to the base, said eccentric frame being the supporting surface to which the actuator is mounted, and said eccentric frame being pivotally attached to the sifting table.

3. The shaker table of claim 1, further comprising an intermediate frame, which comprises a series of metal beams configured to engage and fixingly attach to the outer portions of the sifting table,

4. The shaker table of claim 1, wherein the perforations of said sifting plates are shaped in a non-symmetrical manner and the perforations of each sifting plate are oriented perpendicular to each adjoining sifting plate.

5. The shaker table of claim 1, wherein said sifting table comprises two lower tray portions enclosed by side walls, each tray portion having a feeding end and a discharge end, said discharge ends having discharge openings.

6. The shaker table of claim 1, wherein the lower tray portion includes one or more diverters, said diverters being bars elongated across the sifting plates and removably attached to the sifting assembly.

7. The shaker table of claim 1, wherein the actuator assembly provides the sifting table with both lateral oscillating motion and rotational motion across the longitudinal axis of the sifting table.

8. The shaker table of claim 1, wherein the legs of the base are adjustable in length and permits the sifting table to be oriented with varying degrees of slope.

9. The shaker table of claim 1, wherein the sifting table has a feed end and a disposal end, said feed end being configured to receive unpurified powder mixtures, said disposal end including a disposal opening and being configured to discharge particles that do not pass through the perforations of the sifting plates.

10. The shaker table of claim 1, further comprising magnetic separators mounted to the sifting table and engaging the surface of the sifting plates, said magnetic separators being configured to separate ferromagnetic particles from a powder mixture.

11. A shaker table for purifying powder, said shaker table comprising:
(a) a fixed base, having legs that are adjustable in length and permit the sifting table to be oriented with varying degrees of slope;
(b) an actuator assembly, comprising an actuator mounted directly or indirectly to the base, and a drive component connecting the actuator to the sifting table, transferring motion to the sifting table when the actuator is activated, wherein the actuator assembly provides the sifting table with both lateral oscillating motion and rotational motion across the longitudinal axis of the sifting table;
(c) an eccentric frame having a general shape of the internal border of the base, said eccentric frame being fixingly attached to the base, said eccentric frame being the supporting surface to which the actuator is mounted, and said eccentric frame being pivotally attached to the sifting table;
(d) an intermediate frame, which comprises a series of metal beams configured to engage and fixingly attach to the outer portions of the sifting table;
(e) a sifting table; comprising at least one lower tray portion and an upper open portion, said lower tray portion having at least one discharge opening; and
(f) more than one sifting plate being mounted to and covering the upper open portion of the sifting table, said sifting plates having evenly spaced perforations.

12. The shaker table of claim 11, wherein the perforations of said sifting plates are perpendicular to each other.

13. The shaker table of claim 11, wherein said sifting table comprises two lower tapered tray sections arranged longitudinally in series, each with a declining trapezoidal floor bounded laterally by inclined triangular ramps and enclosed by side walls, said two trays being separated by a shared intermediate wall, which divides the interior into two adjacent flow channels, each tapering toward its own discharge end.

14. The shaker table of claim 11, wherein the perforations of said sifting plates are shaped in a non-symmetrical manner and the perforations of each sifting plate are oriented perpendicular to each adjoining sifting plate.

15. A method for purifying animal protein meal, comprising:
(a) loading or feeding animal protein meal onto a shaker table or sifting table, said table comprising:
i) a fixed base;
ii) an actuator assembly, comprising an actuator mounted directly or indirectly to the base, and a drive component connecting the actuator to the sifting table, transferring motion to the sifting table when the actuator is activated;
iii) a sifting table; comprising a lower tray portion and an upper open portion, said lower tray portion having at least one discharge opening; and
iv) more than one sifting plate being mounted to and covering the upper open portion of the sifting table, said sifting plates having evenly spaced perforations;
(b) moving the animal protein meal across the sifting plates, causing particles of certain sizes to fall through the sifting plates into the sifting trays below; and
(c) separating particles into different portions based on size by routing particles falling through each sifting plate into a separate portion or container, and routing particles that do not fall through any sifting plates into a separate portion or container.

16. The method of claim 15, further comprising separating particles with ferromagnetic properties by attaching at least one magnetic separator to the shaker table.

17. The method of claim 15, further comprising an auger conveyer system that feeds animal protein meal onto the shaker table, said auger conveyer system also moving the separated portions of animal protein meal for further processing, combination into an end product, or disposal.

18. The method of claim 15, wherein the actuator assembly is configured to cause the shaker table to move about its longitudinal axis in a manner that causes animal protein meal atop the table to generally move in a direction towards the discharge end and away from the feed end.

19. The method of claim 15, further comprising using diverters to control the flow of animal protein meal passing through the shaker trays.

20. The method of claim 15, further comprising using gravity to assist with moving the animal protein meal away from the feed end and towards the discharge end by adjusting the legs of the base, thereby creating a slope with a decline angle in the direction of the discharge end.
